(19) United States
(12) Patent Application Publication
(10) Pub. No.: US 2024/0409822 A1
(43) Pub. Date: Dec. 12, 2024

(54) PROCESS FOR PURIFYING A PYROLYSIS PRODUCT AND USE OF A PURIFIED PYROLYSIS OIL

(71) Applicant: BASF SE, Ludwigshafen am Rhein (DE)

(72) Inventors: Gisela HIEBER, Ludwigshafen am Rhein (DE); Dagmar Pascale KUNSMANN-KEITEL, Ludwigshafen am Rhein (DE); Artem D. VITYUK, Iselin, NJ (US); Elise M. MOPHETT, Houston, TX (US); Armin LANGE DE OLIVEIRA, Heidelberg (DE); Daniel KOEPKE, Ludwigshafen am Rhein (DE); Christian MUELLER, Ludwigshafen am Rhein (DE); Monica HAAG, Ludwigshafen am Rhein (DE); Michael SCHREIBER, Ludwigshafen am Rhein (DE); Oliver PILARSKI, Ludwigshafen am Rhein (DE); Lisa LOEBNITZ, Ludwigshafen am Rhein (DE); Julian MEYER-KIRSCHNER, Ludwigshafen am Rhein (DE)

(21) Appl. No.: 18/704,575

(22) PCT Filed: Oct. 17, 2022
(86) PCT No.: PCT/EP2022/078768

§ 371 Date: Apr. 25, 2024

(30) Foreign Application Priority Data
Oct. 27, 2021 (EP) 21205066.0

(51) Int. Cl. C10G 25/05; C01B 3/24; C01B 3/32

(52) U.S. Cl. CPC C10G 25/05; C01B 3/24; C01B 3/32; C01B 2203/025; C01B 2203/0266; C01B 2203/1247; C10G 2300/1003; C10G 2300/202

(57) ABSTRACT

A process for purifying a pyrolysis product. for example a pyrolysis oil and/or a pyrolysis gas. originating from pyrolysis of plastic waste is provided. wherein the process comprises contacting a vaporized pyrolysis oil with one or more adsorption materials and condensing the vaporized pyrolysis oil after it has been contacted with the one or more adsorption materials.

Process for purifying a pyrolysis product and use of a purified pyrolysis oil

The present invention relates to a process for purifying a pyrolysis product originating from the pyrolysis of plastic waste to obtain a purified pyrolysis oil having a reduced halogen content in relation to the provided pyrolysis oil.

The invention further relates to the use of said pyrolysis oil, e.g., as feedstock for a (steam) cracker or as feedstock for a partial oxidation unit to produce syngas.

Currently, plastic waste is still largely landfilled or incinerated for heat generation. Chemical recycling is an attractive way to convert waste plastic material into useful chemicals. An important technique for chemically recycling plastic waste is pyrolysis. The pyrolysis is a thermal degradation of plastic waste in an inert atmosphere and yields value added products such as pyrolysis gas, liquid pyrolysis oil and char (residue), wherein pyrolysis oil is the major product. The pyrolysis oil can be used as source for syngas production and/or processed into chemical feedstock such as ethylene, propylene, C4 cuts, etc. for example in a (steam) cracker.

Typically, the plastic waste is mixed plastic waste composed of different types of polymers. The polymers are often composed of carbon and hydrogen in combination with other elements such as halogens that complicate recycling efforts. In particular halogens may be harmful during the further processing of the pyrolysis oil, since they may deactivate or poison catalysts used in the further processing of the pyrolysis oil or cause plugging by the formation of ammonium halide. During (steam) cracking, halogen-containing compounds can damage the cracker by corrosion in that they release hydrogen halide.

When mixed plastics containing polyvinyl chloride (PVC) is thermally degraded, compounds having double carbon bonds and hydrogen chloride are formed. The hydrogen chloride liberated from PVC attacks the compounds having carbon-carbon double bonds leading to the formation of chloroorganic compounds.

Furthermore, plastic waste typically contains heteroatom-containing additives such as flame retardants, stabilizers and plasticizers that have been incorporated to improve the performance of the polymers. Such additives also often comprise nitrogen, halogen and sulfur containing compounds and heavy metals.

Furthermore, plastic waste often may be uncleaned plastics with residue that may also contain elements other than carbon and hydrogen, in particular additional halogen-containing substances.

Therefore, the reduction of the amount of undesired substances such as halogens in the pyrolysis oil is essential for any profit-generating processing of the pyrolysis oil. In particular, a high-quality pyrolysis oil which is rich in carbon and hydrogen and low in elements other than carbon and hydrogen is preferred as feedstock to prevent catalyst deactivation and corrosion problems in downstream refinery processes.

Accordingly, a process for upgrading plastic waste pyrolysis oil by reducing in particular the halogen content in the pyrolysis oil would be highly desirable. Furthermore, it would be desirable to provide a high-quality plastic waste pyrolysis oil that can be converted into high- value end products in an economic process.

In view of the above, it is an object of the present invention to provide for a process which allows to provide a purified pyrolysis oil and which is as easy as possible.

This object is solved by a process according to claim 1.

The term “untreated pyrolysis oil” refers to the pyrolysis oil in a state before the process according to the present invention has been performed. The untreated pyrolysis oil can also be referred to as “crude pyrolysis oil” or “original pyrolysis oil”.

The “untreated pyrolysis oil”, “crude pyrolysis oil” and/or “original pyrolysis oil” is preferably a pyrolysis oil which has already been subjected to a first filtration and/or extraction. However, the “untreated pyrolysis oil”, “crude pyrolysis oil” and/or “original pyrolysis oil” can also be a pyrolysis oil directly resulting from the pyrolysis process.

In the context of the present invention, the term “pyrolysis” relates to a thermal decomposition or degradation of end-of-life plastics under inert conditions and results in a gas, a liquid and a solid char fraction. During the pyrolysis, the plastics are converted into a great variety of chemicals including gases such as H2, C1-C4-alkanes, C2-C4-alkenes, ethyne, propyne, 1-butyne, pyrolysis oil having a boiling temperature of 25° C. to 500° C. and char. The term “pyrolysis” includes slow pyrolysis, fast pyrolysis, flash catalysis and catalytic pyrolysis. These pyrolysis types differ regarding process temperature, heating rate, residence time, feed particle size, etc. resulting in different product quality.

In the context of the present invention, the term “pyrolysis oil” is understood to mean any oil originating from the pyrolysis of plastic waste. The pyrolysis oil is obtained and/or obtainable from pyrolysis of plastic waste.

The term “pyrolysis gas” is in the context of the present invention is understood to mean any gas originating from the pyrolysis of plastic waste. The pyrolysis gas is obtained and/or obtainable from pyrolysis of plastic waste.

The term “pyrolysis product” comprises “pyrolysis oil”, “pyrolysis gas” and mixtures thereof.

In the context of the present invention, the term “plastic waste” refers to any plastic material discarded after use, i.e., the plastic material has reached the end of its useful life. The plastic waste can be pure polymeric plastic waste, mixed plastic waste or film waste, including soiling, adhesive materials, fillers, residues etc. The plastic waste has a nitrogen content, sulfur content, halogen content and optionally also a heavy metal content. The plastic waste can originate from any plastic material containing source. Accordingly, the term “plastic waste” includes industrial and domestic plastic waste including used tires and agricultural and horticultural plastic material. The term “plastic waste” also includes used petroleum-based hydrocarbon material such as used motor oil, machine oil, greases, waxes, etc.

Typically, plastic waste is a mixture of different plastic material, including hydrocarbon plastics, e.g., polyolefins such as polyethylene (HDPE, LDPE) and polypropylene, polystyrene and copolymers thereof, etc., and polymers composed of carbon, hydrogen and other elements such as chlorine, fluorine, oxygen, nitrogen, sulfur, silicone, etc., for example chlorinated plastics, such as polyvinylchloride (PVC), polyvinylidene chloride (PVDC), etc., nitrogen-containing plastics, such as polyamides (PA), polyurethanes (PU), acrylonitrile butadiene styrene (ABS), etc., oxygen-containing plastics such as polyesters, e.g., polyethylene terephthalate (PET), polycarbonate (PC), etc.), silicones and/or sulfur bridges crosslinked rubbers. PET plastic waste is often sorted out before pyrolysis, since PET has a profitable resale value. Accordingly, the plastic waste to be pyrolyzed often contains less than about 10 wt.-%, preferably less than about 5% by weight and most preferably substantially no PET based on the dry weight of the plastic material. One of the major components of waste from electric and electronic equipment are polychlorinated biphenyls (PCB). Typically, the plastic material comprises additives, such as processing aids, plasticizers, flame retardants, pigments, light stabilizers, lubricants, impact modifiers, antistatic agents, antioxidants, etc. These additives may comprise elements other than carbon and hydrogen. For example, bromine is mainly found in connection to flame retardants. Heavy metal compounds may be used as lightfast pigments and/or stabilizers in plastics; cadmium, zinc and lead may be present in heat stabilizers and slip agents used in plastics manufacturing. The plastic waste can also contain residues. Residues in the sense of the invention are contaminants adhering to the plastic waste. The additives and residues are usually present in an amount of less than 50 wt.-%, preferably less than 30 wt.-%, more preferably less than 20 wt.-%, even more preferably less than 10% by weight, based on the total weight of the dry weight plastic.

In the context of the present invention, the abbreviated notation (steam) cracking includes both thermal cracking such as steam cracking and catalytic cracking such as catalytic hydrocracking and fluidized catalytic cracking (FCC). In a similar manner, the abbreviated notation (steam) cracker includes a thermal cracking reactor such as steam cracker, and a catalytic cracking reactor, such as a catalytic hydrocracking reactor and a fluidized catalytic cracking reactor.

In the context of the present description and the accompanying claims, the term “about” preferably means a deviation of the thus described value of ±15%.

The word “essentially” in the context of the present invention encompasses the words “completely”, “wholly” and “all”. The word encompasses a proportion of 90% or more, such as 95% or more; 99% or more; or 100%.

Pyrolysis oil and/or pyrolysis gas as used as starting material and/or raw material preferably originates from the pyrolysis of halogen-containing plastic waste. Furthermore, the plastic waste which is pyrolyzed typically is a nitrogen-containing and sulfur-containing plastic waste. The plastics material used as feedstock for the production of said pyrolysis oil and/or pyrolysis gas can be derived from any source comprising end of life plastic material. The content of sulfur, nitrogen, halogen and, if present, heavy metal of the pyrolysis oil and/or pyrolysis gas can vary and depends on the type of the waste plastic material processed and pyrolysis conditions employed. Pyrolysis processes as such are known. They are described, e.g., in EP 0713906 and WO 95/03375. Suitable pyrolysis oils are also commercially available. The pyrolysis oil typically is a liquid at 15° C. “Liquid at 15° C.” in the terms of the present invention means that the pyrolysis oil has a density of at most of 1.3 g/ml, e.g., a density in the range from 0.65 to 0.98 g/ml, at 15° C. and 1013 mbar, as determined according to DIN EN ISO 12185. However, also waxy pyrolysis oils can be treated in the process of the present invention. A characteristic of waxy pyrolysis oils is typically a melting point of more than 25° C. and/or of less than 100° C., in particular less than 80° C. The melting point is preferably determined by a commercially available temperature sensor.

A process for purifying a pyrolysis product, for example a pyrolysis oil and/or a pyrolysis gas, originating from pyrolysis of plastic waste is provided, wherein the process comprises contacting a vaporized pyrolysis oil with one or more adsorption materials.

The process further comprises condensing the vaporized pyrolysis oil after it has been contacted with the one or more adsorption materials.

Due to the contacting of the pyrolysis oil with the one or more adsorption materials in a vaporized state, i.e., in the gas phase, a contact area between the one or more adsorption materials and the pyrolysis oil is maximized and thus optimized reaction conditions for a dehalogenation are provided.

“Vaporized pyrolysis oil” in the context of the present invention means a pyrolysis oil in the gas phase and/or evaporated pyrolysis oil. “Vaporized pyrolysis oil” may also contain or consist of one or more gases resulting from a pyrolysis unit before condensation, directly after pyrolysis. Thus, “vaporized pyrolysis oil” may comprise or correspond to “pyrolysis gas”.

Depending on the quality of the pyrolysis oil, it can be beneficial if a pretreatment of the pyrolysis oil is performed before it is contacted with the one or more adsorption materials. For example, the pyrolysis oil is filtrated and/or water is removed before it is contacted with the one or more adsorption materials.

As additional or alternative pretreatment, the pyrolysis oil can be distilled before it is contacted with the one or more adsorption materials

Due to the distillation, a pre-purification is achieved. Furthermore, high boilers and/or solids can be removed and/or avoided.

However, besides a pretreatment of the pyrolysis oil before vaporization, it is also possible, that the process, e.g., a purification system in which the process is preformed, is directly connected with a pyrolysis unit and that the vaporized pyrolysis oil directly resulting from pyrolysis is used for the process either before or after condensation.

Preferably, the pyrolysis oil is supplied to a reaction chamber of a purification system by a conveying element, preferably a pump or a dropping funnel. In particular, the pyrolysis oil is added in a liquid state to the reaction chamber or an evaporator before the reaction chamber.

In embodiments, in which the vaporized pyrolysis oil is obtained directly from pyrolysis, the pyrolysis oil can be supplied to the reaction chamber already in a vaporized state.

In particular for optimized reaction conditions, a hydrogen gas stream or an inert gas stream is supplied to a reaction chamber of a purification system, wherein preferably the inert gas is a noble gas, for example argon, or nitrogen. On an industrial level, nitrogen is preferred as inert gas due to reduced costs compared to the costs of noble gases. Preferably, the hydrogen gas stream or the inert gas stream is supplied simultaneously to a supply of the pyrolysis product, for example the pyrolysis oil, into the purification system.

It is beneficial, if the pyrolysis oil is vaporized in an evaporation zone of a purification system, for example in an evaporation zone of a reactor. In particular, the evaporation zone is formed by an evaporator. On an industrial scale, preferably, a separate evaporator is used. Preferably, a temperature in the evaporation zone is about 250° C. or more, for example about 275° C. or more and/or about 500° C. or less, for example about 450° C. or less.

For example, the purification system may be directly coupled to a cracker, preferably a steam cracker, or a partial oxidation unit. A hydrotreatment and/or hydrocracking unit might be added in between the purification system and the steam cracker or the partial oxidation unit.

Preferably, a load of the pyrolysis oil is about 10 ml/h per 100 ml adsorption material or more and/or about 150 ml/h per 100 ml adsorption material or less, in particular about 20 ml/h per 100 ml adsorption material or more and/or about 95 ml/h or less.

In the evaporation zone, preferably, there is a packing arranged in order to optimize evaporation and/or vaporization. Presently, Raschig rings are used as packing. However, a different filling material, for example made of glass and/or metal, can be used, such as Pall rings.

Preferable, the vaporized pyrolysis oil is contacted with the one or more adsorption materials in a contacting zone of the purification system. On a lab scale, the contacting zone and the evaporation zone can both be located in the same column of the purification system. On an industrial scale, the evaporation zone and the contacting zone are, preferably, separate elements.

According to an aspect of the invention, one or more of the one or more adsorption materials is a molecular sieve, in particular activated charcoal or a zeolite, an alumina, in particular a silica- alumina, for example a silica-alumina hydrate and/or an iron oxide (Fe₂O₃)-based material and/or a copper oxide (CuO)-based material.

In the context of the present description and the accompanying claims, “zeolites” are microporous, aluminosilicate minerals which are commercially available under the term “zeolite”. In particular, zeolites have a porous structure that can accommodate a wide variety of cations, such as sodium ions, potassium ions, calcium ions, magnesium ions and others. These positive ions are rather loosely held and can readily be exchanged for others in a contact solution.

Preferably, while contacting the vaporized pyrolysis oil with the one or more adsorption materials, a dehalogenation of the vaporized pyrolysis oil is performed. In particular, a temperature during the dehalogenation is about 250° C. or more, preferably about 275° C. or more. The temperature during the dehalogenation is preferably about 500° C. or less. The temperature during the dehalogenation preferably corresponds to the temperature in the reaction chamber of the reactor.

It can be beneficial, if one or more of the one or more adsorption materials is a particulate material, wherein preferably an average particle size d50 of the particulate adsorption material is about 25000 μm or less, preferably about 6500 μm or less, preferably about 2000 μm or less, in particular about 500 μm or less, for example about 50 μm or less.

In particular, the average particle size d50 of the adsorption material is about 10 μm or more.

The average particle size d50 is preferably determined by optical methods or by an air sieve, for example by various instruments, namely, Cilas Granulometer 1064 supplied by Quantachrome, Malvern Mastersizer or Luftstrahlsieb (air sieve) supplied by Alpine.

Preferably, an average pore volume of one or more or the adsorption materials is about 0.2 ml/g to about 2.0 ml/g.

In particular, an average pore size of one or more of the one or more adsorption materials is about 1 Å to about 15 Å.

For example, one or more of the one or more adsorption materials has a surface area (BET) of about 300 m²/g to about 900 m²/g.

The surface area of the respective adsorption material is preferably measured by using an instrument supplied by Quantachrome (Nova series) or by Micromeritics (Gemini series). The method entails low temperature adsorption of nitrogen at the BET region of the adsorption isotherm.

Preferably, the one or more adsorption materials reacts with halogens contained in the vaporized pyrolysis oil forming compounds such as sodium halide, calcium halide, iron halide, copper halide.

In particular, the one or more adsorption materials can be partially regenerated under a gas stream, for example an inert gas stream, and/or at a temperature of about 250° C. or more, preferably about 275° C. or more.

Preferably, the one or more adsorption materials are partially regenerated at a temperature of about 500° C. or less.

In addition or in the alternative to mentioned treatment, for partial regeneration of the one or more adsorption materials, adsorbed material can be burned off using air and/or oxygen.

In accordance with a preferred embodiment, a purification system, in which the process is performed, is operated either in a dehalogenation mode or in a regeneration mode in an alternating manner. During the dehalogenation mode, the vaporized pyrolysis oil is either generated or supplied and contacted with the one or more adsorption materials. During the regeneration mode, no vaporized pyrolysis oil is supplied and/or generated, in particular so that material that blocks adsorption sites of the one or more adsorption materials, such as carbon, can desorb.

Preferably, one or more of the one or more adsorption materials contains silica (SiO₂) and/or one or more transition metal oxides, preferably copper oxide (CuO) and/or iron oxide (Fe₂O₃), wherein for example the one or more adsorption materials comprise copper oxide, iron oxide and alumina or consist of the same.

Preferably, a final halogen content of purified pyrolysis oil is about 45% or less, in particular about 40% or less, of the halogen content of the original pyrolysis oil.

As mentioned, it is possible that the vaporized pyrolysis oil is obtained directly from the pyrolysis of plastic waste.

The invention further relates to the use of a purified pyrolysis oil which has been purified according to the process of the invention.

In particular, the invention relates to the use of a purified pyrolysis oil obtainable or obtained by a process of the present invention as feedstock for a cracker, preferably a steam cracker, or as feedstock for a partial oxidation unit to produce syngas.

Before the purified pyrolysis oil is fed into a steam cracker or a partial oxidation unit, preferably a hydrotreatment and/or hydrocracking is performed.

In the cracker, for example in a steam cracker, hydrocarbon compounds having a lower molecular weight than the compounds mostly contained in the pyrolysis product, for example the pyrolysis oil, can be obtained.

Features and/or advantages described in connection with the process of the present invention are valid regarding the use of the purified pyrolysis oil, too.

For the purposes of producing advantageous embodiments of the invention, particular ones or several of the features described in this description and the accompanying claims can be utilized or omitted at will in combination with further features or independently of further features.

Further preferred features and/or advantages of the present invention form the subject matter of the following description and the graphical illustration of exemplary embodiments.

In the drawings:

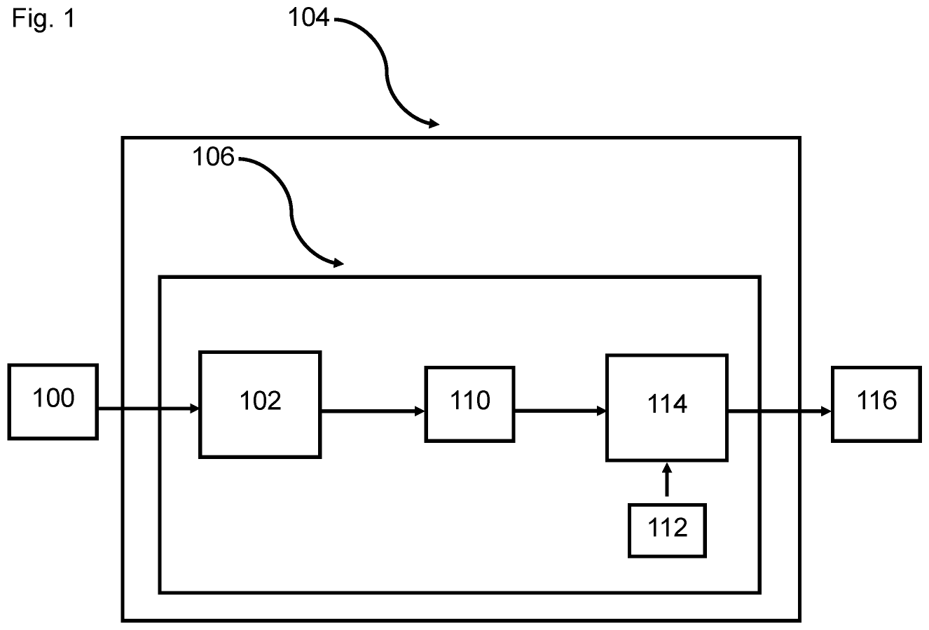

FIG. 1 schematically shows an embodiment of a process for purifying a pyrolysis product originating from pyrolysis of plastic waste in the form of a pyrolysis oil and/or a pyrolysis gas by performing a dehalogenation in the gas phase;

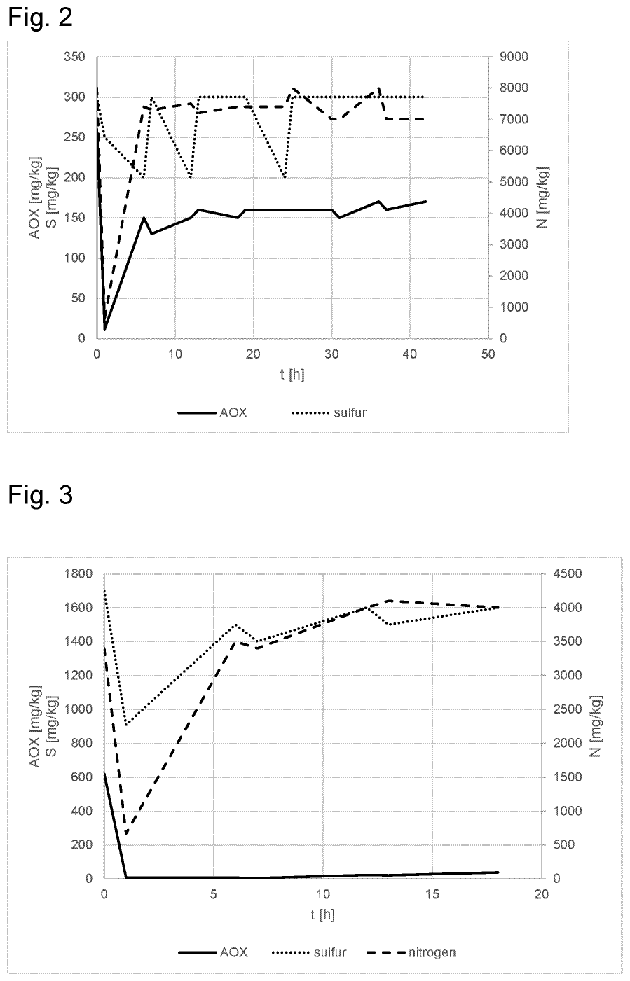

FIG. 2 shows a diagram of the halogen content over time, wherein the halogen content was determined while the process according to Example 1 was performed;

FIG. 3 shows a diagram of the halogen content over time, wherein the halogen content was determined while the process according to Example 2 was performed; and

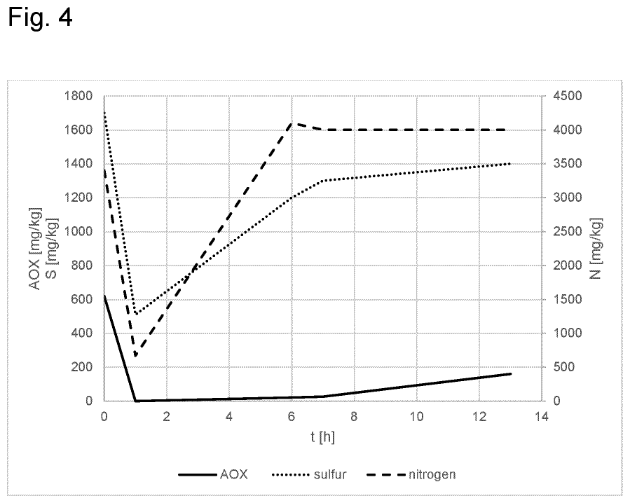

FIG. 4 shows a diagram of the halogen content over time, wherein the halogen content was determined while the process according to Example 3 was performed.

FIG. 1 shows an embodiment of a process for purifying a pyrolysis product originating from pyrolysis of plastic waste, presently in the form of a pyrolysis oil 100, by a dehalogenation. The pyrolysis product can additionally or in the alternative also be a pyrolysis gas obtained directly from pyrolysis.

FIGS. 2 to 4 show graphs of preferred examples and illustrate particular aspects of the invention. In the graphs depicted in FIGS. 2 to 4, the halogen content (AOX), sulfur content(S) and nitrogen content (N) is plotted in mg/kg on the Y-axis and the time t is plotted in h (hours) on the X-axis, respectively. The scale of the Y-axis on the left refers to the halogen content and the sulfur content, while the scale of the Y-axis in the right refers to the nitrogen content. The graphs will be further described below after the Examples.

The described process is preferably used for obtaining a purified pyrolysis oil 116 before its further use. A preferred use of a pyrolysis oil 100 treated by the process is the use in a cracker, for example a steam cracker, or in a partial oxidation unit for the production of syngas (both not graphically shown). However, before a pyrolysis oil that has been purified according to the present process is used in a steam cracker or a partial oxidation unit, preferably a hydrotreatment and/or hydrocracking is performed.

In view of the above, the pyrolysis oil can be used as source for syngas production and/or processed into chemical feedstock such as ethylene, propylene, C4 cuts, etc. for example in a cracker, for example in a steam cracker.

Typically, the original pyrolysis oil 100 has a halogen content of about 10 mg/kg or more, often about 40 mg/kg or more, for example about 80 mg/kg or more.

Typically, the original pyrolysis oil 100 has a halogen content of about 1500 mg/kg or less, often about 1000 mg/kg or less, for example about 800 mg/kg or less.

The halogen content is presently determined by elemental analysis, for example using coulometric titration.

According to the present embodiment, a pyrolysis oil 100 is used, which has been distilled before use in the below described process. As pyrolysis oil 100 for the present process, the low boiler fraction having a sump temperature of about 350° C. or less is used.

However, in addition to distillation or in the alternative thereto, also a pretreatment in the form of filtration and/or water separation can be performed.

The pyrolysis oil 100 is presently evaporated and/or vaporized. For evaporation and/or vaporization, the pyrolysis oil 100 in the liquid state is presently passed through an evaporation zone 102 of a purification system 104. On a lab scale, the evaporation zone 102 can be part of a reaction chamber in a reactor 106, preferably a column, which is part of the purification system 104. On an industrial scale, the evaporation zone 102 is preferably formed by a separate evaporator. The separate evaporator is preferably arranged in a direction of flow of the pyrolysis oil 100 before the reaction chamber. The reaction chamber is preferably the part of the purification system 104 in which a dehalogenation occurs.

A temperature of the evaporation zone 102 is presently set to about 250° C. or more, preferably about 275° C. or more. In particular the temperature in the evaporation zone 102 is set to about 500° C. or less, for example about 450° C. or less.

In the evaporation zone 102, there is a packing arranged in order to optimize evaporation and/or vaporization. Presently Raschig rings are used as packing.

From the evaporation and/or vaporization, a vaporized pyrolysis oil 110 is obtained.

However, as an alternative to evaporation and/or vaporization of pyrolysis oil 100 in the liquid state, it is possible to integrate the present process into the pyrolysis unit of the plastic waste so that vaporized pyrolysis oil 110 is obtained directly from pyrolysis.

On a lab scale, the pyrolysis oil 100 in the liquid state is presently supplied into the reactor 106 from the above (referring to an orientation of the column in a used state and in gravitational direction). The pyrolysis oil 100 is supplied with a conveying device, for example a dropping funnel or a pump.

Using an amount of adsorption material 112 of about 50 ml, the pyrolysis oil 100 can be supplied with a mass flux of about 8 g/h (gram per hour) to about 25 g/h.

In particular, the process is performed under a hydrogen gas stream or an inert gas stream, preferably noble gas stream, for example an argon stream, or a nitrogen stream, in the reactor 106.

In particular simultaneously to the supply of the pyrolysis oil 100 in the liquid state or in the gas state directly after pyrolysis, an argon gas stream is supplied, for example with a volume flow rate of about 6 l/h or more, for example about 12 l/h or more. For example, the hydrogen gas or the inert gas is supplied to the reactor 106, presently the column, from above.

The vaporized pyrolysis oil 110 (corresponding to a pyrolysis oil in the gas phase) is contacted with one or more adsorption materials 112 in a contacting zone 114. The contacting zone 114 is presently part of the reactor 106 (here: the column).

The contacting zone 114 is presently arranged below the evaporation zone 102 and/or in a main direction of flow of the pyrolysis oil 110 downstream of the evaporation zone 102.

The main direction of flow of the vaporized pyrolysis oil 110 is pointing away from a pyrolysis oil 100 inlet and/or pointing downwards.

Preferably, one or more of the one or more adsorption materials 112 is a molecular sieve, in particular activated charcoal or a zeolite, preferably an alumina material, in particular a silica- alumina material, for example a silica-alumina hydrate. In addition or in the alternative, one or more of the one or more adsorption materials 112 is an iron oxide (Fe₂O₃)-based material and/or a copper oxide (CuO)-based material.

Particularly preferred as adsorption material 112 are silica-alumina hydrates having a ratio between alumina (Al₂O₃) and silica (SiO₂) of about 1:1 or more and/or about 2:1 or less, for example about 3:2.

According to this example, preferably, a loose bulk density of the adsorption material 112 is 200 g/l or more and/or about 500 g/l or less.

According to a further preferred embodiment, a molecular sieve is used as adsorption material which is an alumosilicate. For example, a ratio between alumina and silica is 0.5:2 and 1.5:2. Preferably, the alumosilicate contains one or more of the following oxides: potassium oxide, sodium oxide and/or calcium oxide.

For the mentioned alumosilicates, the loose bulk density is preferably 200 g/l or more and/or about 800 g/l or less.

According to a further preferred example, one or more of the one or more adsorption materials 112 contains silica (SiO₂) and/or one or more transition metal oxides, preferably copper oxide (CuO) and/or iron oxide (Fe₂O₃), wherein for example the one or more adsorption materials comprise copper oxide, iron oxide and alumina or consist of the same.

Presently, one or more of the one or more adsorption materials 112 is a particulate material, wherein preferably an average particle size d50 of the particulate adsorption material 112 is 25000 μm or less, preferably about 6500 μm or less, preferably about 2000 μm or less, in particular about 500 um or less, for example about 50 μm or less.

Preferably, the average particle size of the adsorption material 112 is about 10 μm or more.

The average particle size d50 is preferably determined by optical methods or by an air sieve, for example by various instruments, namely, Cilas Granulometer 1064 supplied by Quantachrome, Malvern Mastersizer or Luftstrahlsieb (air sieve) supplied by Alpine.

Additionally or in the alternative, one or more of the one or more adsorption materials 112 has one or more of the following properties:
an average pore volume of about 0.2 ml/g to about 2.0 ml/g; and/or
an average pore size of about 1 Å to about 15 Å; and/or
a surface area (BET) of about 300 m²/g to about 900 m²/g.

The surface area of the respective adsorption material 112 can be measured by using an instrument supplied by Quantachrome (Nova series) or by Micromeritics (Gemini series). The method entails low temperature adsorption of nitrogen at the BET region of the adsorption isotherm.

A temperature within the reactor 106 during the process is presently set to about 250° C. or more, preferably about 275° C. or more. In particular, a temperature of about 500° C. or less, for example of about 450° C. or less, is set within the reactor 106 during the process.

In particular, during contact of the vaporized pyrolysis oil 110 and the one or more adsorption materials 112, a dehalogenation of the vaporized pyrolysis oil 110 occurs.

A load of the pyrolysis oil 110 is preferably about 10 ml/h per 100 ml adsorption material 112 or more and/or about 150 ml/h per 100 ml adsorption material 112 or less.

Preferably, the load of the pyrolysis oil 110 is about 20 ml/h per 100 ml adsorption material or more and/or about 95 ml/h or less.

After contacting the vaporized pyrolysis oil 110 with the one or more adsorption materials 112 (and after a dehalogenation has been performed to a desired level), the vaporized pyrolysis oil 110 is condensed, for example by using a cooling element, while a purified pyrolysis oil 116 is obtained.

Preferably, the final halogen content of the purified pyrolysis oil 116 is about 45% or less, in particular about 40% or less, of the halogen content of the original pyrolysis product (here: the original pyrolysis oil 100).

In particular preferred embodiments, the final halogen content of the purified pyrolysis oil 116 can be about 10% or less of the halogen content of the original pyrolysis product (here: the original pyrolysis oil 100).

Preferably, the temperature of the evaporation zone 102 and/or the reactor 106 as a whole is controlled by a temperature control element which is part of the purification system 104.

The adsorption material 112 can be partially regenerated if it is heated, preferably to about 250° C. or more, preferably to about 275° C. or more and/or about 500° C. or less. For partial regeneration, preferably a gas stream, for example an inert gas stream, or a hydrogen gas stream is provided.

In addition or in the alternative to the mentioned treatment, for partial regeneration of the adsorption material 112, the adsorption material 112 can be burned off using air and/or oxygen.

Thus, performance of the adsorption material 112 over time can be optimized.

The invention will be described in more detail by the subsequent preferred examples.

### EXAMPLES

Starting materials:

The pyrolysis oils used in the examples were prepared in analogy to the process described in EP 0713906.

The following pyrolysis oils were used:
pyrolysis oil 1 having a sulfur content of 300 mg/kg, a nitrogen content of 8000 mg/kg and a halogen content of 260 mg/kg;
pyrolysis oil 2 having a sulfur content of 1700 mg/kg, a nitrogen content of 3400 mg/kg and a halogen content of 620 mg/kg.

Product analyses:

The halogen content (sum of the content of chlorine, bromine and iodine) is determined by combustion of the respective sample at about 1050° C. Resulting combustion gases, i.e., hydrogen chloride, hydrogen bromide and hydrogen iodide, are led into a cell in which coulometric titration a performed.

The nitrogen content is determined by combustion of the respective sample at about 1000° C. NO contained in resulting combustion gases reacts with ozone so that NO₂* is formed. Relaxation of excited nitrogen species is detected by chemiluminescence detectors.

The sulfur content is determined by combustion of the respective sample at about 1000° C. Sulfur dioxide which is contained in resulting combustion gases is excited by UV (ultraviolet) light. Light which is emitted during relaxation is detected by UV fluorescence detectors.

All pyrolysis oils were distilled and the low boiler fraction (here: having a sump temperature up to about 350° C.) was used for the process, respectively.

### Example 1:

The distilled pyrolysis oil (1) 100 is supplied from above to a reaction chamber in a reactor 106 by a conveying element in the form of a dropping funnel or a pump. A mass flux of the pyrolysis oil 100 is presently set to about 16 g/h (gram per hour). Simultaneously, a gas stream of argon is supplied with a volume flow rate of about 12 l/h.

Presently, as reactor 106, a column is used. As packing, Raschig rings are arranged in an upper part of the column, where the evaporation zone 102 is located. The evaporation zone 102 has a temperature of about 375° C.

After the pyrolysis oil has passed the evaporation zone 102, where it is completely vaporized, it is brought into contact with an adsorption material 112. Presently, 50 ml (corresponding to 32.9 g) of an adsorption material 112 in the form of an alumina material, obtained under the product name CL-750 (containing alumina, a surface modifier and 0.015 wt.-% silica) from BASF Corporation, Iselin, New Jersey, 08830, USA, is filled into the column.

The process is performed for 42 hours (corresponding to the time the pyrolysis oil feed was running). The pyrolysis oil feed was interrupted overnight.

After 1 (one) hour of run time for the dehalogenation, a halogen content of the purified pyrolysis oil 116 is about 12 mg/kg.

Afterwards, only a minimum halogen content of about 130 mg/kg to about 170 mg/kg is reached. This shift of the minimum is most probably a consequence of an occupancy of adsorption sites of the adsorption material 112 with carbon.

The purification and/or dehalogenation according to Example 1 is further illustrated in the diagram shown in FIG. 2. The solid black line corresponds to the halogen content (organic halides (AOX)) in mg/kg over time t in hours (h). The dotted line corresponds to the sulfur content in mg/kg over time t in hours (h). The respective scale for the halogen content and the sulfur content is on the Y-axis on the left. The dashed line corresponds to the nitrogen content in mg/kg over time t in hours (h). The respective scale is on the Y-axis on the right.

From FIG. 2 it is clear that the halogen content is reduced due to the described process. A minimum halogen content is reached after 1 (one) hour.

### Example 2:

The distilled pyrolysis oil (2) 100 is supplied from above to a reaction chamber in a reactor 106 by a conveying element in the form of a dropping funnel or a pump. A mass flux of the pyrolysis oil 100 is presently set to about 16 g/h (gram per hour). Simultaneously, a gas stream of argon is supplied with a volume flow rate of about 12 l/h.

Presently, as reactor 106, a column is used. As packing, Raschig rings are arranged in an upper part of the column, where the evaporation zone 102 is located. The evaporation zone 102 has a temperature of about 375° C.

After the pyrolysis oil has passed the evaporation zone 102, where it is completely vaporized, it is brought into contact with an adsorption material 112. Presently, 50 ml (corresponding to 32.2 g) of an adsorption material 112 in the form of an alumina material, obtained under the product name CL-750 (containing alumina, a surface modifier and 0.015 wt.-% silica) from BASF Corporation, Iselin, New Jersey, 08830, USA, is filled into the column.

The process is performed for 18 hours (corresponding to the time the pyrolysis oil feed was running). The pyrolysis oil feed was interrupted overnight.

After 1 (one) hour, the halogen content is about 7 mg/kg. After a run time of seven hours, a minimum halogen content of 5 mg/kg of the purified pyrolysis oil 116 is reached.

The purification and/or dehalogenation according to Example 2 is further illustrated in the diagram shown in FIG. 3. The solid black line corresponds to the halogen content (AOX) in mg/kg over time t in hours (h). The dotted line corresponds to the sulfur content in mg/kg over time t in hours (h). The respective scale for the halogen content and the sulfur content is on the Y-axis on the left. The dashed line corresponds to the nitrogen content in mg/kg over time t in hours (h). The respective scale is on the Y-axis on the right.

From FIG. 3 it is clear that the halogen content is reduced due to the described process. As mentioned above, a minimum halogen content is reached after 7 hours.

The comparison between Example 1 and Example 2 illustrates that the process leads to a drastic reduction of the halogen content for different starting materials.

### Example 3:

The distilled pyrolysis oil (2) 100 is supplied from above to a reaction chamber in a reactor 106 by a conveying element in the form of a dropping funnel or a pump. A mass flux of the pyrolysis oil 100 is presently set to about 16 g/h (gram per hour). Simultaneously, a gas stream of argon is supplied with a volume flow rate of about 12 l/h.

Presently, as reactor 106, a column is used. As packing, Raschig rings are arranged in an upper part of the column, where the evaporation zone 102 is located. The evaporation zone 102 has a temperature of about 375° C.

After the pyrolysis oil has passed the evaporation zone, where it is completely vaporized, it is brought into contact with an adsorption material 112. Presently, 50 ml (corresponding to 36.6 g) of an adsorption material 112 in the form of a material consisting of 6.8 wt.-% copper oxide (CuO), 34.9 wt.-% alumina (Al₂O₃) and 57.3 wt.-% iron oxide (Fe₂O₃) is used.

The process is performed for 13 hours (corresponding to the time the pyrolysis oil feed was running). The pyrolysis oil feed was interrupted overnight.

After a run time of 1 (one) hour, the halogen content is less than 2 mg/kg.

The purification and/or dehalogenation according to Example 3 is further illustrated in the diagram shown in FIG. 4. The solid black line corresponds to the halogen content (AOX) in mg/kg over time t in hours (h). The dotted line corresponds to the sulfur content in mg/kg over time t in hours (h). The respective scale for the halogen content and the sulfur content is on the Y-axis on the left. The dashed line corresponds to the nitrogen content in mg/kg over time t in hours (h). The respective scale is on the Y-axis on the right.

From FIG. 4 it is clear that the halogen content is reduced due to the described process. As mentioned above, a minimum halogen content is reached after 1 (one) hour.

The comparison between Example 2 and Example 3 illustrates that the process leads to a drastic reduction of the halogen content for different adsorption materials.

With the process described above, a purified pyrolysis oil 116 can be obtained by a gas phase dehalogenation.

1-15. (canceled)

16. A process for purifying a pyrolysis product originating from pyrolysis of plastic waste, wherein the process comprises:
contacting a vaporized pyrolysis oil with one or more adsorption materials;
condensing the vaporized pyrolysis oil after it has been contacted with the one or more adsorption materials.

17. The process according to claim 16, wherein a pretreatment of the pyrolysis oil is performed, before it is contacted with the one or more adsorption materials.

18. The process according to claim 16, wherein the pyrolysis oil is supplied to a reaction chamber of a purification system by a conveying element.

19. The process according to claim 16, wherein, a hydrogen gas stream or an inert gas stream is supplied to a reaction chamber of a purification system.

20. The process according to claim 16, wherein the pyrolysis oil is vaporized in an evaporation zone of a purification system.

21. The process according to claim 16, wherein a load of the pyrolysis oil is about 10 ml/h per 100 ml adsorption material or more and/or about 150 ml/h per 100 ml adsorption material or less.

22. The process according to claim 16, wherein one or more of the one or more adsorption materials is a molecular sieve.

23. The process according to claim 16, wherein while contacting the vaporized pyrolysis oil with the one or more adsorption materials, a dehalogenation of the vaporized pyrolysis oil is performed.

24. The process according to claim 16, wherein one or more of the one or more adsorption materials is a particulate material.

25. The process according to claim 16, wherein one or more of the one or more adsorption materials has one or more of the following properties:
an average pore volume of about 0.2 ml/g to about 2.0 ml/g; and/or
an average pore size of about 1 Å to about 15 Å.

26. The process according to claim 16, wherein the one or more adsorption materials are partially regenerated under a gas stream and/or at a temperature of about 250° C. or more, and/or adsorbed material is burned off using air and/or oxygen.

27. The process according to claim 16, wherein one or more of the one or more adsorption materials contains silica (SiO₂) and/or one or more transition metal oxides.

28. The process according to claim 16, wherein a final halogen content of purified pyrolysis oil is about 45% or less of the halogen content of the original pyrolysis product.

29. The process according to claim 16, wherein the vaporized pyrolysis oil is directly obtained from the pyrolysis of plastic waste.

30. A feedstock for a cracker or a partial oxidation unit to produce syngas comprising a purified pyrolysis oil obtained by the process according to claim 16.
